(19) United States
(12) Patent Application Publication
(10) Pub. No.: US 2025/0175997 A1
(43) Pub. Date: May 29, 2025

(54) EXPLICIT REQUEST DESIGN FOR INTER-UE COORDINATION

(71) Applicant: Apple Inc., Cupertino, CA (US)

(72) Inventors: Chunxuan YE, San Diego, CA (US); Dawei ZHANG, Saratoga, CA (US); Haitong SUN, Cupertino, CA (US); Hong HE, San Jose, CA (US); Huaning NIU, San Jose, CA (US); Oghenekome OTERI, San Diego, CA (US); Seyed Ali Akbar FAKOORIAN, San Diego, CA (US); Wei ZENG, Saratoga, CA (US); Weidong YANG, San Diego, CA (US); Yushu ZHANG, Beijing (CN)

(21) Appl. No.: 18/726,995

(22) PCT Filed: Jan. 7, 2022
(86) PCT No.: PCT/CN2022/070805

§ 371 Date: Jul. 5, 2024

(51) Int. Cl. H04W 72/25; H04W 72/566

(52) U.S. Cl. CPC H04W 72/25; H04W 72/566

(57) ABSTRACT

Disclosed are methods, systems, and computer-readable medium to perform operations including: detecting one or more triggers for transmitting an explicit request for inter-UE coordination from an assisting UE; in response to detecting the one or more triggers, generating the explicit request to be sent to the assisting UE; and transmitting the explicit request to the assisting UE.

### TECHNICAL FIELD

The present disclosure relates to wireless devices, and more particularly to apparatus, systems, and methods for a wireless device to perform a variety of cellular communication techniques.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

More recently, wireless communication networks have integrated vehicle communication, where vehicles or other mobile devices communicate or exchange vehicle related information. Such wireless communication networks are referred to as vehicle-to-everything (V2X) communication systems. V2X communication systems may be characterized as networks in which vehicles, UEs, and/or other devices and network entities exchange communications in order to coordinate traffic activity, among other possible purposes. V2X communications include communications conveyed between a vehicle (e.g., a wireless device or communication device constituting part of the vehicle, or contained in or otherwise carried along by the vehicle) and various other devices. V2X communications include vehicle-to-pedestrian (V2P), vehicle-to-infrastructure (V2I), vehicle-to-network (V2N), and vehicle-to-vehicle (V2V) communications, as well as communications between vehicles and other possible network entities or devices. V2X communications may also refer to communications between other non-vehicle devices participating in a V2X network for the purpose of sharing V2X-related information.

### SUMMARY

In accordance with one aspect of the present disclosure, a method involves detecting one or more triggers for transmitting an explicit request for inter-UE coordination from an assisting UE; in response to detecting the one or more triggers, generating the explicit request to be sent to the assisting UE; and transmitting the explicit request to the assisting UE.

The previously-described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, the one or more triggers include determining that the assisting UE is capable of sending inter-UE coordination information.

In some implementations, determining that the assisting UE is capable of sending inter-UE coordination information involves determining, using one of PC5-RRC signaling or high layer signaling with the assisting UE, that the assisting UE is capable of sending the inter-UE coordination information.

In some implementations, the one or more triggers further include determining a transport block for transmission by the UE satisfies at least one of a plurality of secondary conditions, the plurality of secondary conditions include: a latency requirement of the transport block is greater than a predetermined threshold; sensing results at the UE are not satisfactory; a data priority of the transport block is greater than a predetermined threshold; a channel busy ratio is greater than a predetermined threshold; and the transport block is scheduled to be sent to the assisting UE.

In some implementations, generating the explicit request to be sent to the assisting UE involves: generating a container for the explicit request, the container comprising one of: a Medium Access Control (MAC) Control Element (CE), a PC5-radio resource control (PC5-RRC) message, or a sidelink control information (SCI) stage-2 message.

In some implementations, the explicit request includes at least one of: a priority value, a number of requested sub-channels, resource block groups to be used for inter-UE coordination, a resource reservation interval, a source ID, a destination ID, a number of requested time resources, an indication of preferred or non-preferred resources, an indication whether inter-UE coordination information is contained in sidelink control information (SCI) stage-2 signaling, an indication of a starting time of a window of the requested resources, an indication of duration of the window of the requested resources, a resource reselection counter (Cᵣₑₛₑₗ), or a number, N, of combination of (time resource indicator value, frequency resource indicator value, resource reservation periodicity).

In some implementations, the number of requested sub-channels is represented using ┌log₂(N_{subChannel}^{SL})┐, where N_{subChannel}^{SL} is a number of sub-channels in a resource pool available for sidelink communications.

In some implementations, the resource reservation interval is represented using ┌log₂(Nᵣₛᵥ_{_{period}})┐, where Nᵣₛᵥ_{_{period}} is a number of supported resource reservation periods in a resource pool available for sidelink communications.

In some implementations, the indication of the starting time of the window of the requested resources and the indication of the duration of the window of the requested resources is a joint indication.

In some implementations, transmitting the explicit request to the assisting UE involves selecting wireless resources for transmitting the explicit request.

In some implementations, selecting the wireless resources for transmitting the explicit request involves one of: selecting from a set resources that are dedicated for the explicit request; or selecting the wireless resources for the explicit request using resource selection.

In some implementations, selecting the wireless resources for the explicit request using resource selection involves at least one of: determining a priority value for the explicit request; determining that a number of sub-channels used for the explicit request is equal to 1; determining a number of time resources for the explicit request; determining a latency requirement for the explicit request; determining that a resource reservation periodicity for the explicit request is equal to 0; or determining that a resource reselection counter (Cᵣₑₛₑₗ) for the explicit request is equal to 0.

In some implementations, a cast-type of the explicit request is one of unicast or groupcast.

In some implementations, transmitting the explicit request to the assisting UE involves multiplexing the explicit request with a sidelink data transmission.

In some implementations, multiplexing the explicit request with a sidelink data transmission involves determining to multiplex the explicit request with the sidelink data transmission in response to at least one of: determining that a priority of a transport block associated with the explicit request is higher than or equal to a priority of the sidelink transmission; or determining that a latency of the transport block associated with the explicit request is no more than a latency of the sidelink data transmission plus an offset.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example vehicle-to-everything (V2X) communication system 100, according to some embodiments.

FIG. 2 illustrates a communication chart of an assisted user equipment (UE) requesting inter-UE coordination information from an assisting UE, according to some embodiments.

FIG. 3A illustrates a flowchart of an example method, according to some embodiments.

FIG. 3B illustrates a flowchart of another example method, according to some embodiments.

FIG. 4 illustrates a UE, according to some embodiments.

FIG. 5 illustrates an access node, according to some embodiments.

### DETAILED DESCRIPTION

One of the features for vehicle to everything (V2X) under development by the 3rd Generation Partnership Project (3GPP) is inter-UE coordination. This feature, also referred to as an enhancement of “mode 2,” allows a UE (called an “assisting UE” or “UE-A”) to assist another UE (called an “assisted UE” or “UE-B”) with resource selection. There are two schemes within inter-UE coordination. In the first scheme, “Scheme 1,” UE-A provides UE-B with a set of preferred and/or non-preferred resources to be used by UE-B. In the second scheme, “Scheme 2,” UE-A provides UE-B with an indication of the presence of expected conflict on the resources indicated by UE-B's SCI.

One of the advantages of inter-UE coordination is mitigation of the hidden node problem in V2X systems. The hidden node problem occurs in a scenario where two (or more) different UEs are communicating with a common UE, and the two different UEs are hidden to one another. In this scenario, because the two different UEs are hidden to each other, the UEs may use conflicting resources to communicate with the common UE. As a result, at least one of the communications to the common UE is likely to fail. Inter-UE coordination mitigates this problem by enabling the common UE to coordinate the resources that are used by the two different UEs, thereby avoiding the two different UEs from using conflicting resources.

Another advantage of inter-UE coordination is mitigation of the half-duplex issue. The half-duplex issue occurs in scenarios where a transmitter UE (e.g., UE-B) has a transport block (TB) to send to a receiver UE (e.g., UE-A), but the receiver UE cannot receive sidelink data in certain slots due to half-duplex (i.e., the receiver UE may be transmitting in those slots and the receiver UE does not support simultaneous transmission and reception). Inter-UE coordination mitigates this problem by enabling the receiver UE to control the resources that are used by the transmitter UE. As such, the receiver UE can restrict the transmitter UE from using resources that the receiver UE has dedicated to other communications. In Scheme 1, the set of resources selected for UE-B's transmission is a form of candidate single-slot resource selection (e.g., as specified in TS 38.214 Section 8.1.4).

Recently, 3GPP agreements have specified that inter-UE coordination can be triggered by an explicit request from UE-B. The details of the explicit request are under development. This disclosure describes methods and systems for enabling explicit requests, including methods and systems related to triggering conditions of explicit requests, contents of explicit requests, transmission of explicit requests, and multiplexing explicit requests with data transmissions. By enabling explicit requests, the disclosed methods and systems allow UEs operating in V2X systems to avoid communication problems, such as the hidden node and half-duplex problems described above.

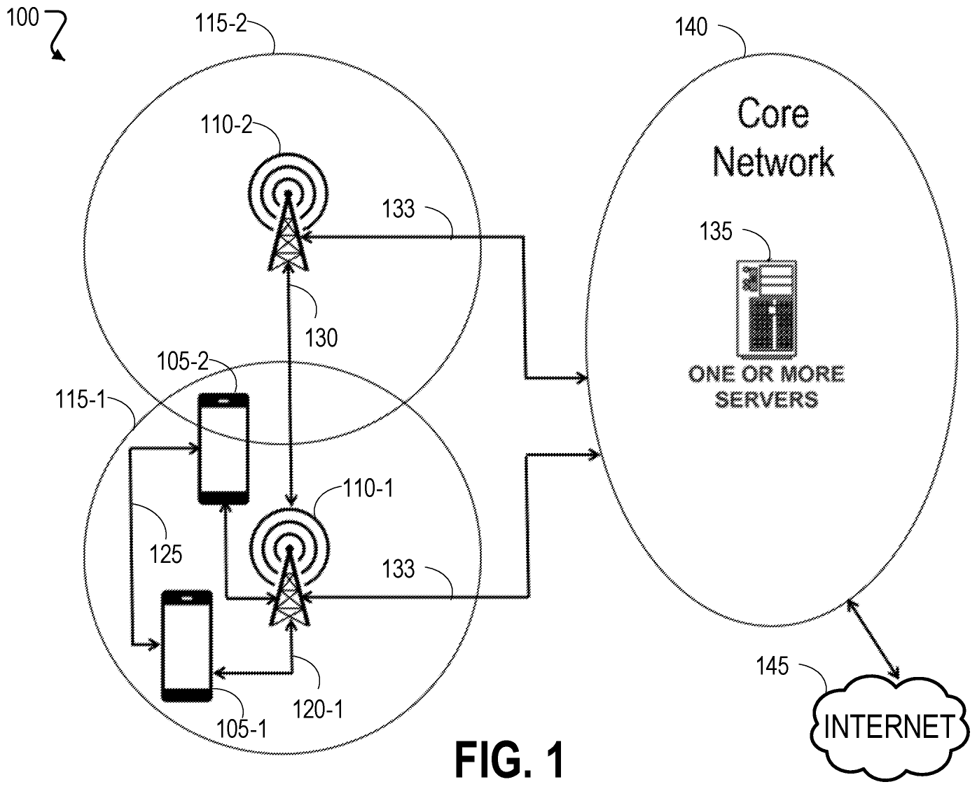

FIG. 1 illustrates an example vehicle-to-everything (V2X) communication system 100, according to some embodiments. It is noted that the system of FIG. 1 is merely one example of a possible system, and that features of this disclosure may be implemented in other wireless communication systems.

The following description is provided for an example V2X communication system 100 that operates in conjunction with fifth generation (5G) networks as provided by 3rd Generation Partnership Project (3GPP) technical specifications (TS). However, the example embodiments are not limited in this regard and the described embodiments may apply to other networks that may benefit from the principles described herein, such as 3GPP Long Term Evolution (LTE) networks, Wi-Fi or Worldwide Interoperability for Microwave Access (WiMax) networks, and the like. Furthermore, other types of communication standards are possible, including future 3GPP systems (e.g., Sixth Generation (6G)) systems, IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short-to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards.

As shown, the V2X communication system 100 includes a number of user devices. As used herein in the context of V2X systems, and as defined above, the term “user devices” may refer generally to devices that are associated with mobile actors or traffic participants in the V2X system, i.e., mobile (able-to-move) communication devices such as vehicles and pedestrian user equipment (PUE) devices. More specifically, the V2X communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

As shown, certain user devices may be able to conduct communications with one another directly, i.e., without an intermediary infrastructure device such as base station 110-1. As shown, UE 105-1 may conduct V2X-related communications directly with UE 105-2. Similarly, the UE 105-2 may conduct V2X-related communications directly with UE 105-2. Such peer-to-peer communications may utilize a “sidelink” interface such as a PC5 interface. In certain embodiments, the PC5 interface supports direct cellular communication between user devices (e.g., between UEs 105), while the Uu interface supports cellular communications with infrastructure devices such as base stations. For example, the UEs 105 may use the PC-5 interface for a radio resource control (RRC) signaling exchange between the UEs. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

In some embodiments, UEs 105 may be physical hardware devices capable of running one or more applications, capable of accessing network services via one or more radio links 120 with a corresponding base station 110, and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs (not shown in FIG. 1) and vice versa. The channels may include the Physical Sidelink Broadcast Channel (PSBCH), Physical Sidelink Control Channel (PSCCH), Physical Sidelink Discovery Channel (PSDCH), Physical Sidelink Shared Channel (PSSCH), and/or any other like communications channels. In some examples, PSSCH can be scheduled by sidelink control information (SCI) carried in the sidelink PSCCH. The SCI in NR V2X is transmitted in two stages. The 1st-stage SCI in NR V2X is carried on the PSCCH while the 2nd-stage SCI is carried on the corresponding PSSCH. For example, 2-stage SCI can be used by applying the 1st SCI for the purpose of sensing and broadcast communication, and the 2^{nd} SCI carrying the remaining information for data scheduling of unicast/groupcast data transmission.

The air interface between two or more UEs 105 and a UE 105 and a UE-type RSU (not shown in FIG. 1) may be referred to as a PC5 interface. To transmit/receive data to/from one or more eNBs 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1. UE 105 may connect with base station 110-1 via link 120 and simultaneously connect with UE 105-2 via sidelink 125.

In some embodiments, the UEs 105 are configured to use a resource pool for sidelink communications. A sidelink resource pool may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some aspects, a UE may use different sub-channels for transmission of the transport block across multiple slots within its own resource selection window, which may be determined using packet delay budget information. In one embodiment, a UE can use discontinuous transmission in time (total TX duration for one transport block (TB) is N slots, e.g., N=1, 2, 3, 4 . . . ) with channel access granularity equal to one slot, where channel access boundaries may be aligned from system perspective at slot level.

In some embodiments, the V2X communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some embodiments, the V2X communication system 100 implements inter-UE coordination. Accordingly, one or more user devices of the V2X communication system 100 may support inter-UE coordination. As an example, the UE 105-1 may be an assisting UE (UE-A) and UE 105-2 may be an assisted UE (UE-B), or vice-versa. In this example, UE-A controls the resources that are used by UE-B. As described above, UE-B (e.g., the UE 105-2) may be send an explicit request to UE-A (e.g., the UE 105-1) for inter-UE coordination information.

In some embodiments, UE-B is configured with triggering conditions for generating an explicit request for inter-UE coordination. The UE-B may be configured to generate an explicit request in response to determining that the triggering conditions have been satisfied. In some examples, a first triggering condition is knowledge of the existence of a UE-A capable of sending inter-UE coordination message. Thus, the first triggering condition is that UE-B knows of a UE-A capable of participating in inter-UE coordination. UE-B may be configured to use one of a plurality of alternative methods for determining that a UE-A is capable of participating in inter-UE coordination. In a first alternative method, which is applicable in unicast communications, the UE-B determines via a PC5-RRC communication that UE-A is capable of sending inter-UE coordination information. In a second alternative method, which is applicable in unicast or groupcast communications, UE-B uses high layer signaling (e.g., V2X layer or application layer signaling) with UE-A to determine that UE-A is capable of sending inter-UE coordination information. Other alternative methods are also possible.

In some examples, a second triggering condition is that the transport block for transmission by UE-B satisfies one or more secondary conditions. A first secondary condition may be that a latency requirement, e.g., Packet Delay Budget (PDB), of the transport block is greater than a predetermined threshold. The exchange of an explicit request and IUC between UE-A and UE-B will take time (e.g., 10 slots). If UE-B's TB needs to be delivered in a short time (e.g., 8 slots), then UE-B may decide not to trigger IUC, since by the time UE-B receives the IUC from UE-A, it may already too late to send UE-B's TB due to its latency requirement. A second secondary condition may be a determination that sensing results at UE-B are not satisfactory. As an example, sensing results at UE-B are not satisfactory in scenarios where UE-B performs only partial sensing or no sensing, or where UE-B does not monitor channels due to transmissions being scheduled in a large number of slots (e.g., a threshold number of slots). As another example, sensing results at UE-B are not satisfactory when the number of sensed slots at UE-B is less than a predetermined threshold, which may be (pre) configured by resource pool.

A third secondary condition may be that the data priority of the transport block is greater than a predetermined threshold (e.g., a threshold that indicates high priority data). If the data priority of the transport block is greater than a predetermined threshold, then UE-B can dedicate resources/time to obtain the IUC from UE-A, which is aimed to increase the transmission reliability. A fourth secondary condition is that a channel busy ratio (e.g., of the resource pool) is greater than a predetermined threshold. If the CBR is high, then the channel is more congested and UE-B's data transmission has a greater chance of colliding with another UE's transmission. Therefore, UE-B can dedicate time/resources to obtain IUC from UE-A to further enhance its data transmission reliability. A fifth secondary condition may be that the transport block is scheduled to be sent to UE-A. Here, UE-B can dedicate resources/time to obtain the IUC from UE-A since it knows that UE-A can provide the information.

In some embodiments, a container of the explicit request may be a Medium Access Control (MAC) Control Element (CE), a PC5-RRC message sent via PSSCH, or a SCI stage-2 message. In some examples, the content of the explicit request may include one or more of: a priority value, a number of sub-channels, resource block groups allocated for inter-UE coordination, a resource reservation interval, a source ID, a destination ID, a number of time domain resources for the transport block, an indication of preferred or non-preferred resources, an indication whether the inter-UE coordination information is (additionally) contained in SCI stage 2, an indication of a starting time of the window of requested resources (e.g., the preferred or non-preferred resources), a duration of the window of requested resources, a resource reselection counter (Cᵣₑₛₑₗ), and a number, N, of combinations of time resource indicator value (TRIV), frequency RIV (FRIV), resource reservation periodicity (e.g., as described in TS 38.214 Section 8.1.5). Note that PSCCH/PSSCH allocation is indicated through the frequency resource assignment and time resource assignment fields, in a form of time RIV (TRIV) and frequency RIV (FRIV).

In an example, the number of sub-channels is represented using ┌log₂(N_{subChannel}^{SL})┐, where N_{subChannel}^{SL} is a number of sub-channels in a resource pool. In an example, the resource reservation interval is represented using ┌log₂(Nᵣₛᵥ_{_{period}})┐, where Nᵣₛᵥ_{_{period}} is the number of supported resource reservation periods in a resource pool.

In some embodiments, the explicit request includes a joint indication of the starting time and duration of the window of resources. In these embodiments, the starting time and the duration are represented using a resource indicator value (RIV) that is calculated as follows:

$$If {t}_{2} - {t}_{1} - 1 \leq ⌊ C / 2 ⌋ , RIV = C ( {t}_{2} - {t}_{1} - 1 ) + ( {t}_{1} - 1 ) ;$$

$$else , RIV = C ( C - ( {t}_{2} - {t}_{1} ) + 1 ) + ( C - {t}_{1} ) .$$

In these equations, t₁ is a time of a starting slot and t₂ is a time of an ending slot, where the times may be relative to the last slot carrying the explicit request. In some examples, t₁ and t₂ may be relative to the last slot carrying the explicit request plus some pre-defined or resource pool (pre) configured offset slot. C is a largest duration possible for an ending slot (relative to the last slot carrying the explicit request (or plus some pre-defined or resource pool (pre) configured offset slot), and may be configured per resource pool or may be configured by the network. In some examples, t₁ and t₂ are subject to the following constraints:

$$1 \leq {t}_{1} \leq C - 1 ;$$

$${t}_{1} < {t}_{2} \leq C .$$

In some embodiments, the explicit request includes separate indication of starting time and duration of the window of resources. In some examples, the starting time is indicated in the explicit request using one of several alternatives. A first alternative is a direct indication. In this alternative, the explicit request includes “A” bits to indicate up to 2^{A} logical slots from the slot carrying explicit request (i.e., the starting time of the window). If there are multiple transmissions of the same explicit request, then the bits represent the number of slots from the slot carrying the last explicit request. The maximum value of A may be preconfigured per resource pool or may be configured via PC5-RRC. A second alternative uses a predetermined table of slot numbers. In this alternative, the explicit request includes a desired table entry index to indicate the number of slots from the slot carrying the explicit request to the start of the window. In an example, the predetermined table of slot numbers is configured per resource pool or via PC5-RRC.

In embodiments where the explicit request includes separate indication of starting time and duration of the window of resources, the duration may be indicated in the explicit request using one of several alternatives. A first alternative is a direct indication. In this alternative, the explicit request includes “B” bits to indicate up to 2^{B} logical slots that represent the duration of the window. The maximum value of B may be preconfigured per resource pool or may be configured via PC5-RRC. A second alternative uses a predetermined table of slot numbers. In this alternative, the explicit request includes a desired table entry index to indicate the number of slots that represent the duration of the window. In an example, the predetermined table of slot numbers is configured per resource pool or via PC5-RRC.

In some embodiments, Cᵣₑₛₑₗ may be indicated in the explicit request using one of several alternatives. A first alternative is a direct indication. In this alternative, the explicit request includes “D” bits to indicate up to 2^{D} possible Cᵣₑₛₑₗ values. The maximum value of D may be preconfigured per resource pool or may be configured via PC5-RRC. A second alternative uses a predetermined table of Cᵣₑₛₑₗ values. In this alternative, the explicit request includes a desired table entry index to indicate the desired Cᵣₑₛₑₗ value in the table. In an example, the predetermined table Cᵣₑₛₑₗ values is configured per resource pool or via PC5-RRC.

In some embodiments, UE-B is configured to select the resources for transmitting the explicit request using one of several alternative methods. In a first alternative method, UE-B selects resources that are dedicated for the explicit request. In one example, the dedicated resources are reserved by either UE-A or UE-B with certain periodicity during an initial capability exchange stage. In another example, the dedicated resources are configured per resource pool.

In a second alternative method, UE-B selects the resources for the explicit request using resource selection. In some examples, the resource selection uses a priority value (e.g., prio_{Tx}). In these examples, the priority value may be preconfigured by resource pool or via PC5-RRC. In other examples, the priority value depends on a priority value of the transport block to be transmitted. In yet other examples, UE-B has another transport block to send to UE-A together with the explicit request. In these examples, the lower of the respective priority values associated with the transport block and the explicit request is used as the priority value.

Further, in the second alternative method, the number of sub-channels (L_{subch}) used for the explicit request is equal to 1. Additionally, the UE-B may use one of several alternatives to determine the number of time resources for the explicit request. In a first alternative, the number of time resources is predetermined (e.g., 1). In a second alternative, the number of time resources is preconfigured by resource pool or via PC5-RRC.

Furthermore, in the second alternative method, the UE-B uses one of several alternatives to determine the PDB for the resources used for the explicit request. In a first alternative, the PDB is equal to the PDB of the transport block for transmission minus some offset. The offset is used for UE-B's receiving and processing of the inter-UE coordination information. In a second alternative, the PDB is preconfigured by resource pool or via PC5-RRC. In a third alternative, the PDB depends on the PDB of the transport block for transmission.

In some examples, the resource reservation periodicity (P_{rsvp_TX}) is equal to 0. In some examples, Cᵣₑₛₑₗ is equal to 0. In some examples, the UE-B uses a specified percentage for the resource selection for explicit request, where the percentage is of the identified candidate resources over all the candidate resources from which the resources are selected. In some examples, the sub-channels in a resource pool used for explicit request transmission may be restricted by resource pool configuration. For example, a resource pool configuration may specify that only the first or last X sub-channels could be used for explicit request transmission.

In some embodiments, the cast-type of the explicit request may be unicast or groupcast. Accordingly, a UE-B may send the explicit request to a particular UE-A via unicast, multiple UE-As via unicast, and/or a group of UE-As via groupcast.

In some embodiments, UE-B may be configured to multiplex an explicit request with sidelink data transmissions. In these embodiments, UE-B may use a MAC CE as a container of the explicit request. Further, UE-B may use the lower of the respective priority values associated with the sidelink and the explicit request as the priority value for the multiplexed communication. In some examples, UE-B is configured with criteria for multiplexing. In one example, UE-B multiplexes the explicit request with a sidelink data transmission when the data priority of the transport block associated with the explicit request is higher than or equal to the priority of the sidelink transmission. In another example, UE-B multiplexes the explicit request with a sidelink data transmission when the PDB of the transport block associated with the explicit request is no more than an offset plus the PDB of the sidelink data transmission.

In some embodiments, in response to receiving the explicit request, the UE-A determines preferred and/or non-preferred resources for the UE-B. In an example, when UE-A determines a set of preferred resources triggered by explicit request, the UE-A applies a legacy resource selection procedure, with the parameters of remaining packet delay budget, Cᵣₑₛₑₗ, and the number of time resources for a TB being either provided or derived from the information in the explicit request.

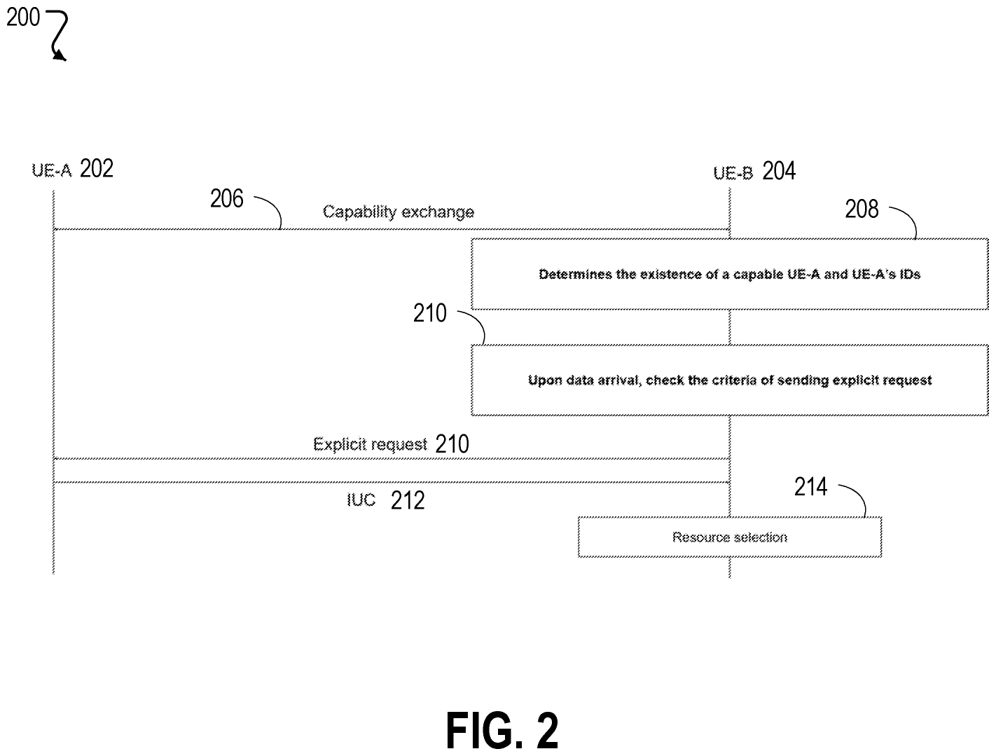

FIG. 2 illustrates a communication chart 200 of an assisted UE 204 requesting inter-UE coordination information from an assisting UE 202, according to some embodiments. As shown in FIG. 2, the assisting UE 202 (labeled as UE-A 202) exchanges capability information 206 with the assisted UE 204 (labeled as UE-B 204). As shown by block 208, based on the capability information, UE-B 204 determines that UE-A 202 is capable of providing inter-UE coordination information. Additionally, UE-B 204 determines the IDs (e.g., layer-1 and layer-2 IDs) of UE-A 202. At block 210, UE-B 204, upon arrival of data for transmission, checks whether the criteria or conditions for sending an explicit request have been satisfied. Examples of such criteria, such as various triggering conditions, which may include determining capability information of UE-A 202 as described with respect to block 208, are described in further detail above in relation to FIG. 1. In response to determining that the criteria have been satisfied, UE-B 204 provides an explicit request 210 to UE-A 202. In response to receiving the explicit request 210, UE-A 202 provides inter-UE coordination (IUC) information 212 to UE 204. At block 214, UE-B 204, in response to receiving the IUC information 212, performs resource selection based on the IUC information 212.

In some embodiments, an assisting UE (UE-A) uses information provided in an explicit request for its resource selection to generate IUC. Thus, when the inter-UE coordination is triggered by explicit request, the parameters used in UE-A's resource selection procedure are provided in the explicit request. For example, UE-A may use at least one of the parameters: number of time domain resources, remaining packet delay budget, starting time and duration of the window, or Cᵣₑₛₑₗ in the resource selection for UE-B. Additionally and/or alternatively, UE-A may use prio_{TX} (data priority), L_{subCH} (the number of sub-channels), P_{rsvp_TX} (resource reservation periodicity), which are provided in the explicit request, in the resource selection for UE-B.

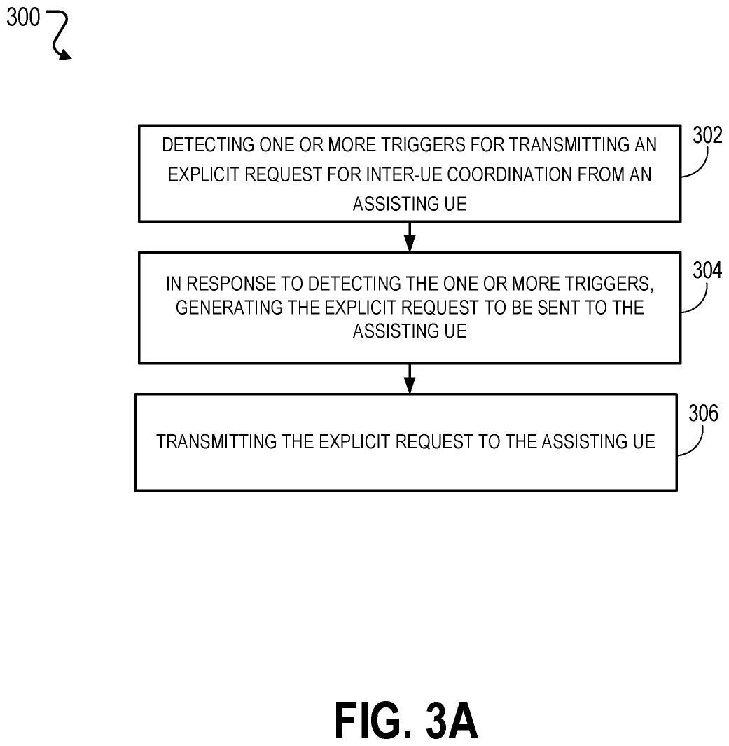

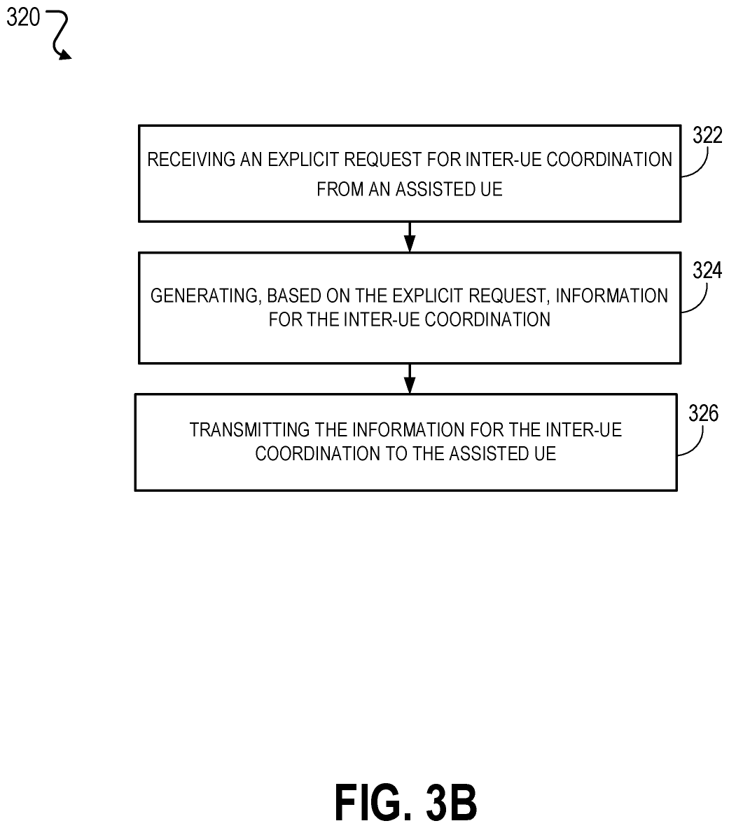

FIG. 3A illustrates a flowchart of an example method 300, according to some implementations. For clarity of presentation, the description that follows generally describes method 300 in the context of the other figures in this description. For example, method 300 can be performed by UE 105 of FIG. 1. It will be understood that method 300 can be performed, for example, by any suitable system, environment, software, hardware, or a combination of systems, environments, software, and hardware, as appropriate. In some implementations, various steps of method 300 can be run in parallel, in combination, in loops, or in any order.

At block 302, method 300 involves detecting one or more triggers for transmitting an explicit request for inter-UE coordination from an assisting UE.

At block 304, method 300 involves in response to detecting the one or more triggers, generating the explicit request to be sent to the assisting UE.

At block 304, method 300 involves transmitting the explicit request to the assisting UE.

In some implementations, the one or more triggers include determining that the assisting UE is capable of sending inter-UE coordination information.

In some implementations, determining that the assisting UE is capable of sending inter-UE coordination information involves determining, using one of PC5-RRC signaling or high layer signaling with the assisting UE, that the assisting UE is capable of sending the inter-UE coordination information.

In some implementations, the one or more triggers further include determining a transport block for transmission by the UE satisfies at least one of a plurality of secondary conditions, the plurality of secondary conditions include: a latency requirement of the transport block is greater than a predetermined threshold; sensing results at the UE are not satisfactory; a data priority of the transport block is greater than a predetermined threshold; a channel busy ratio is greater than a predetermined threshold; and the transport block is scheduled to be sent to the assisting UE.

In some implementations, generating the explicit request to be sent to the assisting UE involves: generating a container for the explicit request, the container comprising one of: a Medium Access Control (MAC) Control Element (CE), a PC5-radio resource control (PC5-RRC) message, or a sidelink control information (SCI) stage-2 message.

In some implementations, the explicit request includes at least one of: a priority value, a number of requested sub-channels, a total number of resource block groups in IUC, a resource reservation interval, a source ID, a destination ID, a number of requested time resources, an indication of preferred or non-preferred resources, an indication whether inter-UE coordination information is contained in sidelink control information (SCI) stage-2 signaling, an indication of a starting time of a window of the requested resources, an indication of duration of the window of the requested resources, or a resource reselection counter (Cᵣₑₛₑₗ).

In some implementations, the number of requested sub-channels is represented using ┌log₂(N_{subChannel}^{SL})┐, where N_{subChannel}^{SL} is a number of sub-channels in a resource pool available for sidelink communications.

In some implementations, the resource reservation interval is represented using ┌log₂(Nᵣₛᵥ_{_{period}})┐, where Nᵣₛᵥ_{_{period}} is a number of supported resource reservation periods in a resource pool available for sidelink communications.

In some implementations, the indication of the starting time of the window of the requested resources and the indication of the duration of the window of the requested resources is a joint indication.

In some implementations, transmitting the explicit request to the assisting UE involves selecting wireless resources for transmitting the explicit request.

In some implementations, selecting the wireless resources for transmitting the explicit request involves one of: selecting from a set resources that are dedicated for the explicit request; or selecting the wireless resources for the explicit request using resource selection.

In some implementations, selecting the wireless resources for the explicit request using resource selection involves at least one of: determining a priority value for the explicit request; determining that a number of sub-channels used for the explicit request is equal to 1; determining a number of time resources for the explicit request; determining a latency requirement for the explicit request; determining that a resource reservation periodicity for the explicit request is equal to 0; or determining that a resource reselection counter (Cᵣₑₛₑₗ) for the explicit request is equal to 0.

In some implementations, a cast-type of the explicit request is one of unicast or groupcast.

In some implementations, transmitting the explicit request to the assisting UE involves multiplexing the explicit request with a sidelink data transmission.

In some implementations, multiplexing the explicit request with a sidelink data transmission involves determining to multiplex the explicit request with the sidelink data transmission in response to at least one of: determining that a priority of a transport block associated with the explicit request is higher than or equal to a priority of the sidelink transmission; or determining that a latency of the transport block associated with the explicit request is no more than a latency of the sidelink data transmission plus an offset.

FIG. 3B illustrates a flowchart of an example method 320, according to some implementations. For clarity of presentation, the description that follows generally describes method 320 in the context of the other figures in this description. For example, method 320 can be performed by UE 105 of FIG. 1. It will be understood that method 320 can be performed, for example, by any suitable system, environment, software, hardware, or a combination of systems, environments, software, and hardware, as appropriate. In some implementations, various steps of method 320 can be run in parallel, in combination, in loops, or in any order.

At 322, method 320 involves receiving an explicit request for inter-UE coordination from an assisted UE.

At 324, method 320 involves generating, based on the explicit request, information for the inter-UE coordination.

At 326, method 320 involves transmitting the information for the inter-UE coordination to the assisted UE.

In some implementations, the explicit request comprises at least one of a number of requested time domain resources, a remaining packet delay budget (Cᵣₑₛₑₗ), a starting time and duration of a window for the requested time domain resources.

In some implementations, the information for the inter-UE coordination comprises information indicative of time-frequency resources for the assisted UE to transmit a transport block.

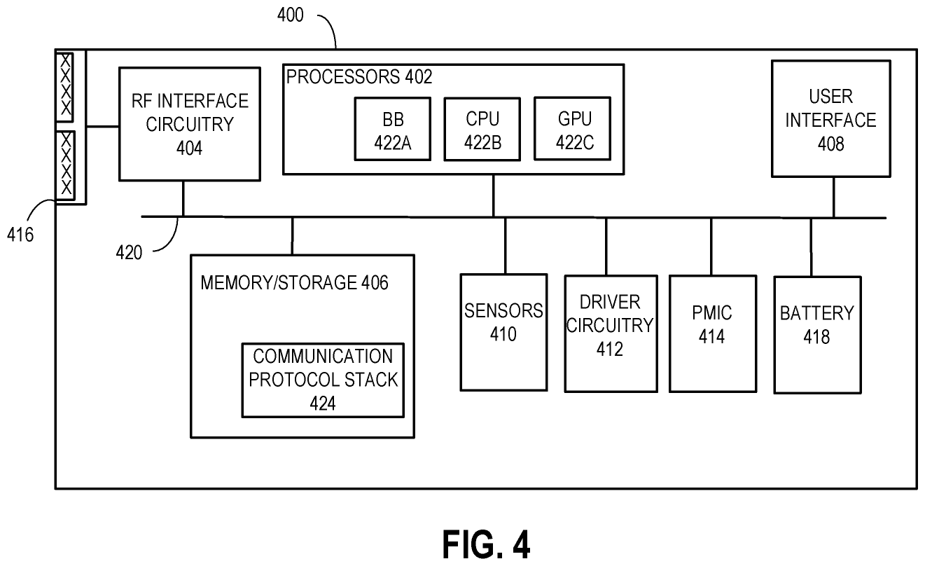

FIG. 4 illustrates a UE 400, in accordance with some embodiments. The UE 400 may be similar to and substantially interchangeable with UE 105 of FIG. 1.

The UE 400 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 400 may include processors 402, RF interface circuitry 404, memory/storage 406, user interface 408, sensors 410, driver circuitry 412, power management integrated circuit (PMIC) 414, antenna structure 416, and battery 418. The components of the UE 400 may be implemented as integrated circuits (ICs), portions thereof, discrete electronic devices, or other modules, logic, hardware, software, firmware, or a combination thereof. The block diagram of FIG. 4 is intended to show a high-level view of some of the components of the UE 400. However, some of the components shown may be omitted, additional components may be present, and different arrangement of the components shown may occur in other implementations.

The components of the UE 400 may be coupled with various other components over one or more interconnects 420, which may represent any type of interface, input/output, bus (local, system, or expansion), transmission line, trace, optical connection, etc. that allows various circuit components (on common or different chips or chipsets) to interact with one another.

The processors 402 may include processor circuitry such as, for example, baseband processor circuitry (BB) 422A, central processor unit circuitry (CPU) 422B, and graphics processor unit circuitry (GPU) 422C. The processors 402 may include any type of circuitry or processor circuitry that executes or otherwise operates computer-executable instructions, such as program code, software modules, or functional processes from memory/storage 406 to cause the UE 400 to perform operations as described herein, including operations described in relation to FIGS. 1-3, for example.

In some embodiments, the baseband processor circuitry 422A may access a communication protocol stack 424 in the memory/storage 406 to communicate over a 3GPP compatible network. In general, the baseband processor circuitry 422A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 404. The baseband processor circuitry 422A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 406 may include one or more non-transitory, computer-readable media that includes instructions (for example, communication protocol stack 424) that may be executed by one or more of the processors 402 to cause the UE 400 to perform various operations described herein, including operations described in relation to FIGS. 1-3, for example. The memory/storage 406 include any type of volatile or non-volatile memory that may be distributed throughout the UE 400. In some embodiments, some of the memory/storage 406 may be located on the processors 402 themselves (for example, L1 and L2 cache), while other memory/storage 406 is external to the processors 402 but accessible thereto via a memory interface. The memory/storage 406 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 404 may include transceiver circuitry and radio frequency front module (RFEM) that allows the UE 400 to communicate with other devices over a radio access network. The RF interface circuitry 404 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 416 and proceed to filter and amplify (with a low-noise amplifier) the signal. The signal may be provided to a receiver of the transceiver that downconverts the RF signal into a baseband signal that is provided to the baseband processor of the processors 402.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 416.

In various embodiments, the RF interface circuitry 404 may be configured to transmit/receive signals in a manner compatible with NR access technologies. In particular, the RF interface circuitry 404 may be configured to transmit/receive signals associated with exchanging capability information, sending/receiving/detecting information associated with triggering conditions for IUC, requests for assistance information from other UEs or assistance information to other UEs, and other operations described above in relation to FIGS. 1-3.

The antenna 416 may include antenna elements to convert electrical signals into radio waves to travel through the air and to convert received radio waves into electrical signals. The antenna elements may be arranged into one or more antenna panels. The antenna 416 may have antenna panels that are omnidirectional, directional, or a combination thereof to enable beamforming and multiple input, multiple output communications. The antenna 416 may include microstrip antennas, printed antennas fabricated on the surface of one or more printed circuit boards, patch antennas, phased array antennas, etc. The antenna 416 may have one or more panels designed for specific frequency bands including bands in FRI or FR2.

The user interface 408 includes various input/output (I/O) devices designed to enable user interaction with the UE 400. The user interface 408 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 400.

The sensors 410 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 412 may include software and hardware elements that operate to control particular devices that are embedded in the UE 400, attached to the UE 400, or otherwise communicatively coupled with the UE 400. The driver circuitry 412 may include individual drivers allowing other components to interact with or control various input/output (I/O) devices that may be present within, or connected to, the UE 400. For example, driver circuitry 412 may include a display driver to control and allow access to a display device, a touchscreen driver to control and allow access to a touchscreen interface, sensor drivers to obtain sensor readings of sensor circuitry 428 and control and allow access to sensor circuitry 428, drivers to obtain actuator positions of electro-mechanic components or control and allow access to the electro-mechanic components, a camera driver to control and allow access to an embedded image capture device, audio drivers to control and allow access to one or more audio devices.

The PMIC 414 may manage power provided to various components of the UE 400. In particular, with respect to the processors 402, the PMIC 414 may control power-source selection, voltage scaling, battery charging, or DC-to-DC conversion.

In some embodiments, the PMIC 414 may control, or otherwise be part of, various power saving mechanisms of the UE 400 including DRX as discussed herein. A battery 418 may power the UE 400, although in some examples the UE 400 may be mounted deployed in a fixed location, and may have a power supply coupled to an electrical grid. The battery 418 may be a lithium ion battery, a metal-air battery, such as a zinc-air battery, an aluminum-air battery, a lithium-air battery, and the like. In some implementations, such as in vehicle-based applications, the battery 418 may be a typical lead-acid automotive battery.

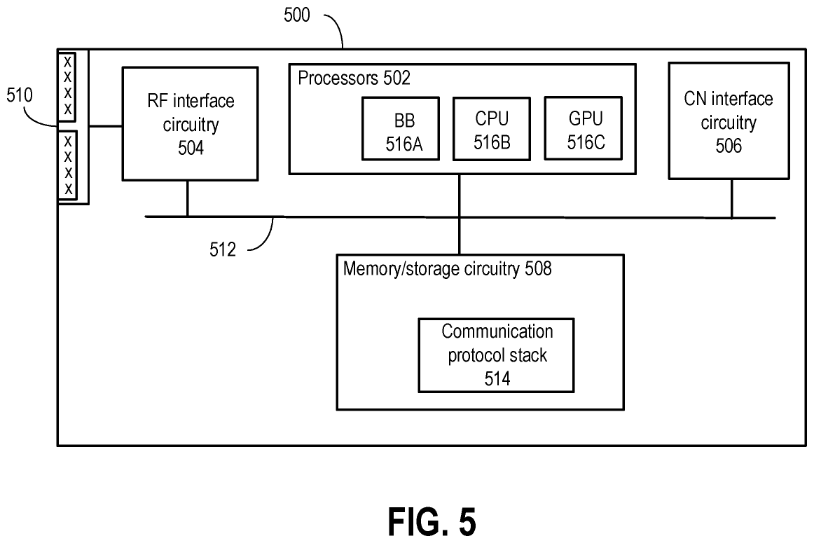

FIG. 5 illustrates an access node 500 (e.g., a base station or gNB), in accordance with some embodiments. The access node 500 may be similar to and substantially interchangeable with base station 110. The access node 500 may include processors 502, RF interface circuitry 504, core network (CN) interface circuitry 506, memory/storage circuitry 508, and antenna structure 510.

The components of the access node 500 may be coupled with various other components over one or more interconnects 512. The processors 502, RF interface circuitry 504, memory/storage circuitry 508 (including communication protocol stack 514), antenna structure 510, and interconnects 512 may be similar to like-named elements shown and described with respect to FIG. 4. For example, the processors 502 may include processor circuitry such as, for example, baseband processor circuitry (BB) 516A, central processor unit circuitry (CPU) 516B, and graphics processor unit circuitry (GPU) 516C.

The CN interface circuitry 506 may provide connectivity to a core network, for example, a 5th Generation Core network (5GC) using a 5GC-compatible network interface protocol such as carrier Ethernet protocols, or some other suitable protocol. Network connectivity may be provided to/from the access node 500 via a fiber optic or wireless backhaul. The CN interface circuitry 506 may include one or more dedicated processors or FPGAs to communicate using one or more of the aforementioned protocols. In some implementations, the CN interface circuitry 506 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to an access node 500 that operates in an NR or 5G system (for example, a gNB), and the term “E-UTRAN node” or the like may refer to an access node 500 that operates in an LTE or 4G system (e.g., an eNB). According to various embodiments, the access node 500 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the access node 500 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by the access node 500; a MAC/PHY split wherein RRC, PDCP, RLC, and MAC layers are operated by the CRAN/vBBUP and the PHY layer is operated by the access node 500; or a “lower PHY” split wherein RRC, PDCP, RLC, MAC layers and upper portions of the PHY layer are operated by the CRAN/vBBUP and lower portions of the PHY layer are operated by the access node 500.

In V2X scenarios, the access node 500 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-20. (canceled)

21. One or more processors configured to perform operations comprising:
generating an explicit request for inter-UE coordination to be transmitted to an assisting user equipment (UE);
determining a priority value of a transmission comprising the explicit request; and
selecting, based on the priority value, wireless resources for the transmission to the assisting UE.

22. The one or more processors of claim 21, wherein selecting, based on the priority value, wireless resources for transmitting the explicit request to the assisting UE:
selecting, based on the priority value, the wireless resources for the explicit request using resource selection.

23. The one or more processors of claim 21, wherein the priority value is a first priority value of the explicit request.

24. The one or more processors of claim 23, wherein the first priority value is based on a priority of a transport block associated with the explicit request.

25. The one or more processors of claim 23, wherein the first priority value is a preconfigured value.

26. The one or more processors of claim 21, the operations further comprising:
multiplexing the explicit request with sidelink data in the transmission.

27. The one or more processors of claim 26, wherein determining the priority value of the transmission comprises:
determining a first priority value of the explicit request;
determining a second priority value for the sidelink data; and
selecting as the priority value the lower one of the first and second priority values.

28. The one or more processors of claim 21, wherein a cast-type of the explicit request is one of unicast or groupcast.

29. A user equipment (UE) device comprising:
one or more processors; and
memory storing instructions that when executed by the one or more processors, cause the UE device to perform operations comprising:
detecting one or more triggers for transmitting an explicit request for inter-UE coordination from an assisting UE;
in response to detecting the one or more triggers, generating the explicit request to be sent to the assisting UE; and
transmitting the explicit request to the assisting UE.

30. The UE device of claim 29, wherein transmitting the explicit request to the assisting UE comprises selecting wireless resources for transmitting the explicit request.

31. The UE device of claim 30, wherein selecting the wireless resources for transmitting the explicit request comprises selecting the wireless resources for the explicit request using resource selection.

32. The UE device of claim 31, wherein selecting the wireless resources for the explicit request using resource selection comprises:
determining a priority value for the explicit request; and
selecting, based on the priority value, the wireless resources using resource selection.

33. The UE device of claim 32, wherein the priority value is: (1) based on a priority of a transport block associated with the explicit request, or (2) a preconfigured value.

34. The UE device of claim 29, wherein transmitting the explicit request to the assisting UE comprises multiplexing the explicit request with a sidelink data transmission.

35. The UE device of claim 34, wherein multiplexing the explicit request with a sidelink data transmission comprises:
determining to multiplex the explicit request with the sidelink data transmission in response to determining that a priority of a transport block associated with the explicit request is higher than or equal to a priority of the sidelink transmission.

36. A method comprising:
generating an explicit request for inter-UE coordination to be transmitted to an assisting user equipment (UE);
determining a priority value of a transmission comprising the explicit request; and
selecting, based on the priority value, wireless resources for the transmission to the assisting UE.

37. The method of claim 36, wherein selecting, based on the priority value, wireless resources for transmitting the explicit request to the assisting UE:
selecting, based on the priority value, the wireless resources for the explicit request using resource selection.

38. The method of claim 36, wherein the priority value is a first priority value of the explicit request.

39. The method of claim 38, wherein the first priority value is: (1) based on a priority of a transport block associated with the explicit request, or (2) a preconfigured value.

40. The method of claim 38, further comprising:
multiplexing the explicit request with sidelink data in the transmission.
